(19) United States
(12) Patent Application Publication
(10) Pub. No.: US 2020/0087951 A1
(43) Pub. Date: Mar. 19, 2020

(54) BICYCLE LOCKING DEVICE HAVING ABNORMAL LOCKING PREVENTION FUNCTION, AND METHOD THEREFOR

(71) Applicant: BISECU INC., Seongnam-si (KR)

(72) Inventors: Jong Hyun LEE, Suwon-si (KR); Jung Ho HYUN, Suwon-si (KR); Ji Soon KANG, Suwon-si (KR); Min Su JANG, Seongnam-si (KR)

(73) Assignee: BISECU INC., Seongnam-si (KR)

(21) Appl. No.: 16/692,801

(22) Filed: Nov. 22, 2019

Related U.S. Application Data
(63) Continuation of application No. PCT/KR2018/005098, filed on May 2, 2018.

(30) Foreign Application Priority Data
May 29, 2017 (KR) 10-2017-0065834

(51) Int. Cl. E05B 71/00; B62H 5/14; E05B 43/00

(52) U.S. Cl. CPC E05B 71/00; B62J 2099/002; E05B 43/005; B62H 5/14

(57) ABSTRACT

The present disclosure relates to a bicycle locking apparatus having an abnormal locking prevention function. The bicycle locking apparatus includes a sensor unit which measures a driving condition of a bicycle to be locked by using a plurality of sensors and outputs sensing data about the driving condition, a locking operation unit which performs a locking operation or an unlocking operation on the bicycle to be locked in response to input of a lock signal or an unlock signal, and a control unit which controls the overall operation of the bicycle locking apparatus. The control unit includes a first driving state determination unit which determines a first state of the bicycle to be locked by using sensing data of a first sensor group, a second driving state determination unit which determines a second state of the bicycle to be locked by using sensing data of a second sensor group.

### CROSS-REFERENCE TO RELATED APPLICATIONS

The present application is a continuation of International Patent Application No. PCT/KR2018/005098, filed May 2, 2018, which is based upon and claims the benefit of priority to Korean Patent Application No. 10-2017-0065834, filed on May 29, 2017. The disclosures of the above-listed applications are hereby incorporated by reference herein in their entirety.

### TECHNICAL FIELD

The present disclosure relates to a bicycle locking apparatus having an abnormal locking prevention function, and a method thereof, and more particularly, to a bicycle locking apparatus which provides an automatic locking function and is designed to prevent an abnormal locking operation in order to ensure the reliability of the automatic locking function and ensure the safety of a bicycle rider, and a method thereof.

### BACKGROUND ART

Bicycles are widely used not only for transportation but also for fitness and leisure because they are lightweight and easy to ride. In particular, bicycles have recently been widely used to save energy in line with the era of high oil prices. While bicycles are easy to use and store anytime, anywhere, they are always vulnerable to theft due to their lightweight characteristics. Therefore, a locking apparatus for preventing theft is usually fastened to a bicycle when the bicycle is stored.

Conventional locking apparatuses widely use a method of manually locking the frame of a bicycle by forming locking parts such as locks at both ends of a metal cable or chain. Recently, however, smart locking apparatuses for automatically performing a locking or unlocking operation according to a predetermined condition have been developed as in Korean Patent No. 1211413.

However, smart locking apparatuses currently being developed are not designed to prevent an abnormal locking problem in which a locking function is performed during driving of a bicycle. Therefore, bicycle riders using the smart locking apparatuses are exposed to the risk of accidents that may occur due to abnormal locking. Nonetheless, developers of smart locking apparatuses are currently focusing only on implementing an automatic locking function that offers convenience to riders and are not interested in an abnormal locking prevention function for ensuring the reliability of the automatic locking function.

Since a smart locking apparatus is an apparatus having an electronic and electrical structure, an abnormal locking operation may be caused by various factors as follows. For example, when a lock signal is triggered by a short circuit, a breakdown, a noise, a wrong signal, etc. that may occur in an apparatus having an electronic and electrical structure, the abnormal locking operation may be performed. For another example, when a locking or unlocking operation of the smart locking apparatus is performed according to a driving state of a bicycle, the abnormal locking operation may be caused by misjudgment of the driving state due to a measurement error of a sensor. For another example, when the locking or unlocking operation of the smart locking apparatus is performed according to a separation distance from a smart phone measured based on the strength of a wireless signal, the abnormal locking operation may be performed if the wireless signal is attenuated or if the smartphone is unintentionally moved away.

In addition, when the locking or unlocking operation of the smart locking apparatus is performed by a user's command input to the smartphone, the abnormal locking operation may be caused by the user's wrong command input.

As described above, the smart locking apparatus has a possibility of performing the abnormal locking operation due to various factors. Therefore, in order to eliminate the possibility of the abnormal locking operation, there is a need for a bicycle locking apparatus designed to prevent the abnormal locking operation in terms of both hardware and/or software.

### DISCLOSURE

### Technical Problem

Provided are a bicycle locking apparatus which provides an automatic locking function according to a predetermined condition and has the function of preventing an abnormal locking operation that may occur during driving, and a method thereof.

Additional aspects will be set forth in part in the description which follows and, in part, will be apparent from the description, or may be learned by practice of the presented embodiments.

### Technical Solution

According to an aspect of the present disclosure, a bicycle locking apparatus having an abnormal locking prevention function, the apparatus may comprise a sensor unit which measures a driving condition of a bicycle to be locked by using a plurality of sensors and outputs sensing data about the driving condition, a locking operation unit which performs a locking operation or an unlocking operation on the bicycle to be locked in response to input of a lock signal or an unlock signal and a control unit which controls the overall operation of the bicycle locking apparatus, wherein the control unit comprises a first driving state determination unit which determines a first state of the bicycle to be locked by using sensing data of a first sensor group comprising one or more of the sensors, a second driving state determination unit which determines a second state of the bicycle to be locked by using sensing data of a second sensor group comprising one or more of the sensors, wherein the sensors included in the second sensor group are different from the sensors included in the first sensor group and a locking control unit which outputs the lock signal to the locking operation unit in response to a locking event that occurs when a predetermined locking condition is satisfied, wherein the locking control unit outputs the lock signal to the locking operation unit only when both the first state and the second state indicate the stop state.

According to an aspect of the present disclosure, an abnormal locking prevention method performed by a locking apparatus having a plurality of sensors, the method may comprise detecting occurrence of a locking event according to a predetermined condition, determining a first state of a bicycle to be locked, to which the locking apparatus is attached, in response to the locking event by using sensing data of a first sensor group comprising one or more of the sensors, determining a second state of the bicycle to be locked by using sensing data of a second sensor group comprising one or more of the sensors, and outputting the lock signal for triggering a locking operation of the locking apparatus only when both the first state and the second state indicate the stop state.

### Advantageous Effects

According to the present disclosure described above, a bicycle locking apparatus designed to prevent abnormal locking in terms of both hardware and software may be provided. Accordingly, the safety of a rider using the locking apparatus can be ensured, and a bicycle accident that may be caused by abnormal locking can be prevented in advance.

More specifically, according to the present disclosure described above, a locking operation unit is powered off when performing a locking operation during driving of a bicycle. Accordingly, an abnormal operation of the locking operation unit due to a wrong control signal can be prevented, and the reliability of an automatic locking function can be improved.

In addition, a locking prevention unit which physically blocks the locking operation of the locking operation unit during driving of the bicycle is operated. Accordingly, even if the locking operation unit is powered to perform the locking operation, an abnormal locking operation is physically blocked by the locking operation unit. Therefore, the reliability of the automatic locking function can be further improved.

In addition, it is determined whether the bicycle is currently in a driving state using sensors provided in the locking apparatus, and the locking operation is prevented if the bicycle is in the driving state. In addition, the driving state of the bicycle is determined based on sensing data, which are measured by a plurality of sensors, in consideration of an error in the sensing data. Accordingly, the accuracy of the driving state determination can be improved, and the problem of the abnormal locking operation being performed due to misjudgment of the driving state can be solved.

In addition, it is possible to accurately determine whether the bicycle is in a temporary stop state while driving by considering various factors such as a locking pattern of the rider, whether the rider is riding on the bicycle, and a tilt of the bicycle. Accordingly, the problem of an automatic locking operation being unnecessarily performed when the bicycle is temporarily stopped while driving can be solved. This can increase the rider's convenience and satisfaction with the locking apparatus.

However, the effects are not restricted to the one set forth herein. The above and other effects will become more apparent to one of daily skill in the art by referencing the claims.

### DESCRIPTION OF DRAWINGS

These and/or other aspects will become apparent and more readily appreciated from the following description of the embodiments, taken in conjunction with the accompanying drawings in which:

FIG. 1 illustrates the configuration of an abnormal locking prevention system according to an embodiment of the present disclosure;

FIG. 2 is a block diagram of a locking apparatus having an abnormal locking prevention function according to another embodiment of the present disclosure;

FIGS. 3 through 7 are diagrams for explaining each component of the bicycle locking apparatus having the abnormal locking prevention function;

FIG. 8 is a flowchart illustrating an abnormal locking prevention method that may be performed in response to an unlocking event;

FIG. 9 is a flowchart illustrating an abnormal locking prevention method that may be performed in response to a locking event; and

FIGS. 10 and 11 illustrate user interfaces of a rider terminal for setting a locking prevention time and a locking prevention place.

### MODE FOR INVENTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Like numbers refer to like elements throughout.

Unless otherwise defined, all terms including technical and scientific terms used herein have the same meaning as commonly understood by one of ordinary skill in the art to which this disclosure belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

Hereinafter, some embodiments of the inventive concept will be described with reference to the drawings.

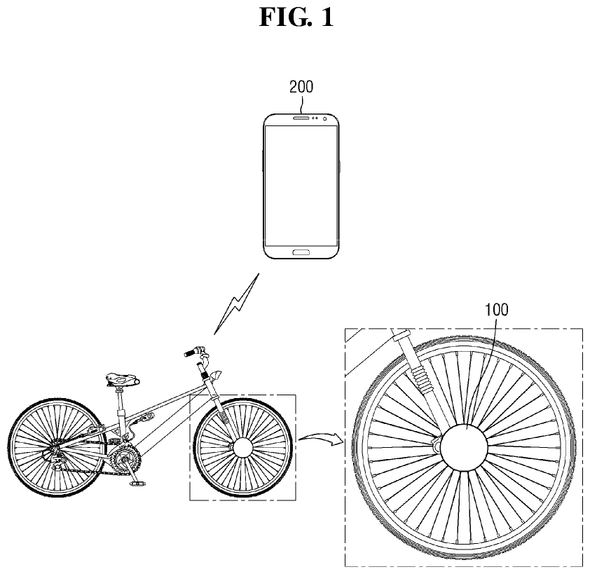

FIG. 1 illustrates the configuration of an abnormal locking prevention system according to an embodiment of the present disclosure.

Referring to FIG. 1, the abnormal locking prevention system may include a bicycle locking apparatus 100 attached to a bicycle to be locked and a rider terminal 200. However, this is merely an embodiment for achieving the objectives of the present disclosure, and some components can be added or removed as needed. For ease of description, the bicycle locking apparatus 100 will hereinafter be referred to as a ‘locking apparatus.’

The locking apparatus 100 is an apparatus attached to a bicycle to be locked so as to lock or unlock the bicycle to be locked and an apparatus designed to prevent an abnormal locking problem in terms of hardware and/or software. In FIG. 1, the locking apparatus 100 is attached to a front wheel of the bicycle to be locked. However, the locking apparatus 100 may be attached to any position as long as it can restrict the movement of the bicycle to be locked. In addition, the locking apparatus 100 may be implemented to be detachable depending on the way the locking apparatus 100 restricts the movement of the bicycle to be locked. In this case, the attachment position of the locking apparatus 100 can be changed by a rider of the bicycle to be locked.

The locking apparatus 100 may automatically perform a locking operation or an unlocking operation in response to a locking event or an unlocking event occurring according to a predetermined condition. For example, the unlocking event may occur when a separation distance between the locking apparatus 100 and the rider terminal 200 is less than a certain distance. For another example, the locking event or the unlocking event may occur according to the rider's command input to the rider terminal 200. For another example, the locking event or the unlocking event may occur when the rider's locking or unlocking command is input to an input device provided in the locking apparatus 100. In addition, there may be various conditions for the occurrence of the locking event or the unlocking event. However, the scope of the present disclosure is not limited to a particular condition.

In the current embodiment, the locking apparatus 100 determines, in real time, a driving state of the bicycle to be locked. In addition, when it is determined that the bicycle to be locked is currently in the driving state, a locking operation is not performed even if the locking event occurs. This is because the locking operation performed during driving can be a great threat to the safety of the rider. For the same reason, the locking apparatus 100 does not perform the locking operation even when determining that the bicycle to be locked is in a temporary stop state while driving.

The rider terminal 200 is a computing device possessed by the rider of the bicycle to he locked. As illustrated in FIG. 1, the computing device may be, but is not limited to, a handheld device such as a smartphone.

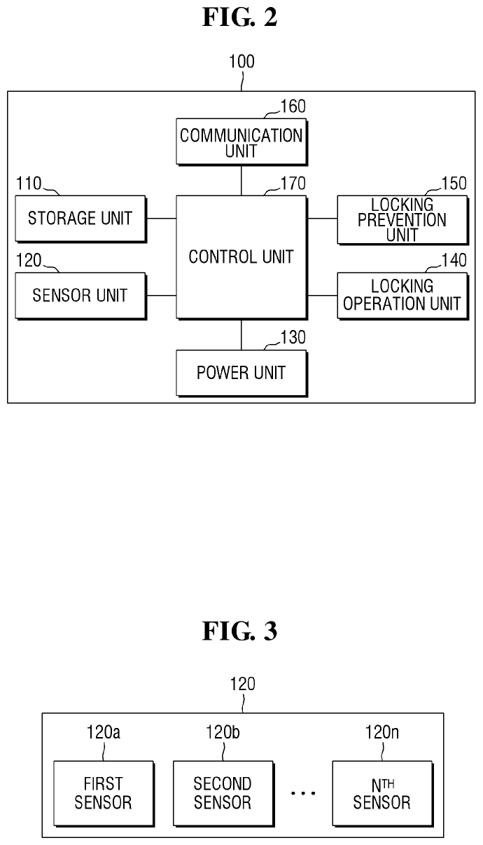

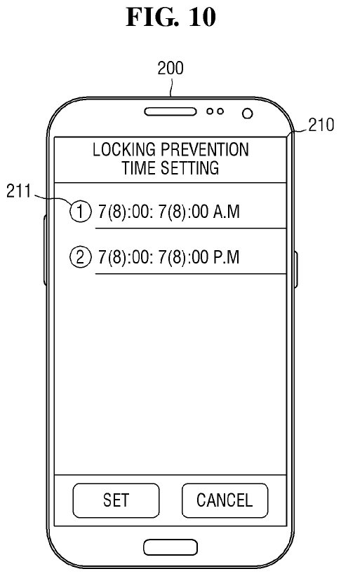

According to embodiments of the present disclosure, the rider terminal 200 may provide driving information or locking prevention information input by the rider to the locking apparatus 100. The driving information may include, for example, a driving departure point and a driving destination, and the locking prevention information may include, for example, a locking prevention time and a locking prevention place. The driving information and the locking prevention information may be utilized by the locking apparatus 100 to prevent abnormal locking. This will be described later with reference to FIGS. 2 and 10.

In the current embodiment, the locking apparatus 100 and the rider terminal 200 may communicate through a network. For example, the network may be implemented as any type of wireless network such as Bluetooth or a wireless local area network (WLAN). However, the scope of the present disclosure is not limited thereto.

Until now, the abnormal locking prevention system according to the embodiment of the present disclosure has been described with reference to FIG. 1. Next, the configuration and operation of a locking apparatus 100 according to an embodiment of the present disclosure will be described with reference to FIGS. 2 through 7.

FIG. 2 is a block diagram of a locking apparatus 100 having an abnormal locking prevention function according to another embodiment of the present disclosure.

Referring to FIG. 2, the locking apparatus 100 may include a storage unit 110, a sensor unit 120, a power unit 130, a locking prevention unit 140, a locking operation unit 150, a communication unit 160, and a control unit 170. In FIG. 2, only the components related to the embodiment of the present disclosure are illustrated. Therefore, it will be understood by those of ordinary skill in the art to which the present disclosure pertains that other general-purpose components can be included in addition o the components illustrated in FIG. 2.

As for each component, the storage unit 110 may temporarily or non-temporarily store various data such as sensing data measured by the sensor unit 120, locking pattern information analyzed by a locking pattern analysis unit 178 to be described later, and driving information received from the rider terminal 200. In particular, the storage unit 110 may store at least one program or application for performing an abnormal locking prevention method according to an embodiment of the present disclosure.

The storage unit 110 may include at least one type of storage medium selected from a flash memory type, a hard disk type, a solid state disk (SSD) type, a silicon disk drive (SDD) type, a multimedia card micro type, a card type memory (e.g., a secure digital (SD) or an extreme digital (XD) memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. Apart from the above examples, the storage unit 110 may include any type of computer-readable recording medium well known in the art to which the present disclosure pertains.

The sensor unit 120 measures, in real time, a driving condition of a bicycle to be locked and outputs sensing data about the driving condition. The sensing data is used by a driving state determination unit 176, which will be described later, to determine, in real time, a driving state of the bicycle to be locked.

According to an embodiment of the present disclosure, the sensor unit 120 may be configured to include a plurality of sensors 120a through 120n as illustrated in FIG. 3. That is, the sensor unit 120 may output various sensing data measured by the sensors 120a through 120n. Therefore, even if measurement errors are included in some of the sensing data, the driving state determination unit 176 can determine a current state of the bicycle to be locked by using the other sensing data. This can improve the accuracy of the driving state determination and also improve the reliability of the sensor unit 120 and/or the locking apparatus 100. For reference, the measurement errors may occur due to various causes, such as when some sensors do not output measurement values and when circuits of some sensors break.

The sensors 120a through 120c may be different types of sensors, or at least some of the sensors may be the same type of sensors. That is, a first sensor 120a and a second sensor 120b may be different types of sensors or may be the same type of sensors. Like this, the type and number of sensors included in the sensor unit 120 may vary depending on embodiments.

Examples of the sensors included in the sensor unit 120 may include an acceleration sensor, a gyro sensor, a geomagnetic sensor, a magnetic sensor for detecting rotation of a bicycle wheel, a pressure sensor, a position measuring sensor such as a global positioning system (GPS), and an image sensor such as a camera.

According to an embodiment, some of the sensors included in the sensor unit 120 may be located independently of the locking apparatus 100. For example, a sensor having a wireless communication function may be installed at a distance from the locking apparatus 100 in some cases in order for measurement accuracy. More specifically, for example, a pressure sensor may be installed in a saddle of the bicycle to the locked in order to accurately determine whether a rider is riding on the bicycle to be locked, and the locking apparatus 100 may be installed at the position illustrated in FIG. 1.

In addition, according to an embodiment, some of the sensing data collected by the locking apparatus 100 to determine the current state of the bicycle to be locked may be collected by the rider terminal 200. For example, the locking apparatus 100 may receive sensing data measured by a sensor provided in the rider terminal 200 and determine the current state of the bicycle to be locked.

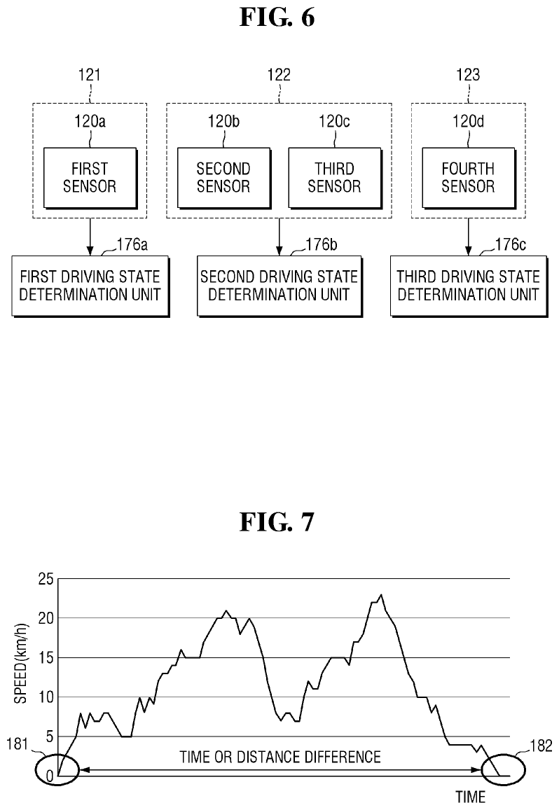

According to an embodiment, the sensors 120a through 120c included in the sensor unit 120 may be divided into a plurality of sensor groups by the control unit 170. In addition, the state of the bicycle to be locked may be individually determined using sensing data measured by each sensor group. For example, a first state of the bicycle to be locked may be determined using sensing data measured by a first sensor group, and a second state of the bicycle to be locked may be determined using sensing data measured by a second sensor group. This embodiment will be described in detail later with reference to FIG. 6. For reference, each sensor group may include one or more sensors and may be logically formed such that the sensors included in each sensor group are different sensors.

Referring again to FIG. 2, the power unit 130 may apply or cut off power to each component of the locking apparatus 100 in response to a control signal of a power control unit 174 to be described later. To this end, the power unit 130 may include a battery for supplying power and a switch for providing a power application and cutoff function.

The locking operation unit 140 performs a locking operation or an unlocking operation on the bicycle to be locked in response to a control signal of a locking control unit 172 to be described later. As described above, the locking operation unit 140 can use any method to physically restrict the movement of the bicycle to be locked through the locking operation.

The locking prevention unit 150 physically blocks the locking operation of the locking operation unit 140 in response to the control signal of the locking control unit 172. The locking prevention unit 150 may be implemented in any form as long as it can physically block the locking operation.

According to an embodiment of the present disclosure, the locking prevention unit 150 may be separated from the locking operation unit 140 in a circuit. Accordingly, even if the locking operation unit 140 malfunctions under the influence of a wrong control signal, the locking prevention unit 150 may block the malfunction of the locking operation unit 140 without being affected by the wrong control signal. Therefore, the reliability of the abnormal locking prevention function can be further improved. For the same reason, a power cutoff module may be provided in the locking prevention unit 150 to perform a power application and cutoff function separately from the locking operation unit 140.

According to an embodiment of the present disclosure, the locking prevention unit 150 may be implemented in a circuit to detect the locking operation of the locking operation unit 140. For example, a switch may be implemented in a circuit so as to be turned on or off according to the locking operation of the locking operation unit 140, and the locking prevention unit 150 may be implemented to detect the state of the switch. The locking prevention unit 150 may also be implemented in any way as long as it can detect the locking operation.

In the current embodiment, when the locking operation of the locking operation unit 140 is detected while the bicycle to be locked is in the driving state, the locking prevention unit 150 may block the locking operation of the locking operation unit 140 even if an anti-lock signal is not received from the locking control unit 172.

The communication unit 160 may support wired and wireless communication of the locking apparatus 100 and transmit and receive various information to and from an external device. The communication unit 160 may receive information such as driving information and/or locking prevention information from an external device such as the rider terminal 200 in order to perform a method according to an embodiment of the present disclosure. In addition, the communication unit 160 may receive user input regarding various selections and commands from the rider terminal 200 and transmit various processing results to the rider terminal 200 in response to the user input.

For example, the communication unit 160 may include, but is not limited to, a Bluetooth communication unit, a Bluetooth low energy (BLE) communication unit, a near field communication unit, a WLAN (Wi-Fi) communication unit, a Zigbee communication unit, an infrared data association (IrDA) communication unit, a Wi-Fi direct (WFD) communication unit, an ultra-wideband (UWB) communication unit, or an Ant+ communication unit.

The control unit 170 controls the overall operation of each component of the locking apparatus 100. The control unit 170 may include a central processing unit (CPU), a micro-processor unit (MPU), a micro-controller unit (MCU), or any form of processor well known in the art to which the present disclosure pertains. The control unit 170 may also include a memory, for example, a RAM. In addition, the control unit 170 may store at least one application or program for executing a method according to an embodiment of the present disclosure.

For example, the control unit 170 may store and execute an abnormal locking prevention program according to an embodiment of the present disclosure. When the control unit 170 executes the abnormal locking prevention program, an abnormal locking prevention method according to an embodiment of the present disclosure may be performed.

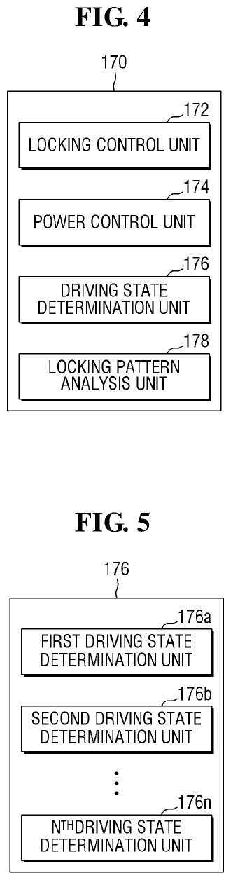

Specifically, in order to perform the abnormal locking prevention method according to the embodiment of the present disclosure, the control unit 170 may include the locking control unit 172, the power control unit 174, the driving state determination unit 176, and the locking pattern analysis unit 178 as illustrated in FIG. 4.

The locking control unit 172 controls the locking operation or the unlocking operation of the locking operation unit 140 in response to a locking event or an unlocking event occurring according to a predetermined condition. Specifically, the locking control unit 172 controls the unlocking operation of the locking operation unit 140 by outputting an unlock signal when the unlocking event occurs according to a predetermined condition and controls the locking operation of the locking operation unit 140 by outputting a lock signal when the locking event occurs according to a predetermined locking condition.

According to an embodiment of the present disclosure, even if the locking event occurs, the locking control unit 172 may not output the lock signal according a determination result of the driving state determination unit 176 which will be described later. In addition, when the driving state determination unit 176 is composed of a plurality of driving state determination units 176a through 176n as illustrated in FIG. 5, if at least one of the driving state determination units 176a through 176n determines that the current state of the bicycle to be locked is the driving state, the locking control unit 172 may not output the lock signal even if the locking event occurs. According to this embodiment, since an abnormal locking operation can be prevented from being performed during driving, a bicycle accident due to abnormal locking can be prevented in advance.

In addition, according to an embodiment of the present disclosure, even if the locking event occurs and the driving state determination unit 176 determines that the bicycle to be locked is in a stop state, the locking control unit 172 may delay outputting the lock signal for a locking delay time. In this embodiment, the locking control unit 172 may output the delayed lock signal only when the stop state of the bicycle to be locked is maintained for the locking delay time. According to this embodiment, the locking control unit 172 may strictly control the locking operation by detecting an additional state change during the locking delay time. Therefore, the reliability of the automatic locking function provided by the locking apparatus 100 can be further improved.

The locking delay time may be a preset, fixed value or a variable value that varies according to a situation.

In an embodiment, the locking delay time may be changed based on a driving speed of the bicycle to be locked. For example, the control unit 170 may update the locking delay time to a larger value as the driving speed of the bicycle to be locked increases. This is because the determination that the driving state of the bicycle to be locked is the stop state is highly likely to be wrong if the rider is riding at high speed.

In an embodiment, the communication unit 160 may receive driving destination information of the bicycle to be locked which is input to the rider terminal 200 input by the rider. In addition, the control unit 170 may adjust the locking delay time based on the received information. Specifically, the locking delay time may vary according to a distance between a current position of the bicycle to be locked and a driving destination. For example, when the distance between the current position of the bicycle to be locked and the driving destination is less than a preset distance, the locking delay time may be updated to a smaller value than before. This is because the bicycle to be locked is highly likely to be parked if the rider reaches near the driving destination.

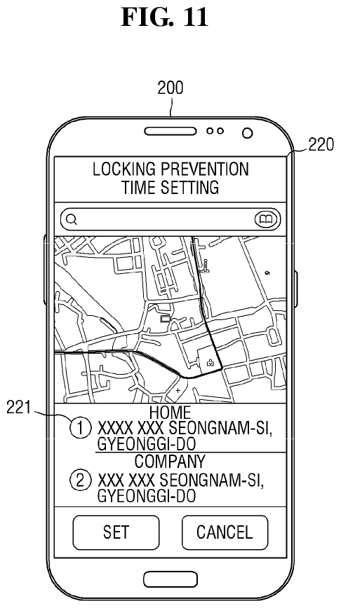

In an embodiment, the communication unit 160 may receive information about a locking prevention time and/or a locking prevention place from the rider terminal 200. In addition, the control unit 170 may adjust the locking delay time based on the received information. This will be described later with reference to FIGS. 10 and 11.

In addition, according to an embodiment of the present disclosure, if the locking event occurs based on a separation distance between the rider terminal 200 and the locking apparatus 100, the control unit 170 may adjust the separation distance based on the locking prevention time and/or the locking prevention place. This will be described later with reference to FIGS. 10 and 11.

In addition, according to an embodiment of the present disclosure, the control unit 170 may control a notification informing the occurrence of the locking event to be provided to the rider terminal 200 when the occurrence of the locking event is detected while a condition, such as reaching the locking prevention time or entering near the locking prevention place, is satisfied. In this case, whether to perform the locking operation may be determined according to the rider's selection. Embodiments of utilizing the locking prevention time and/or the locking prevention place will be described in detail with reference to FIGS. 10 and 11.

The power control unit 174 controls power application and cutoff to each component included in the locking apparatus 100. Specifically, the power control unit 174 controls power application and cutoff to each component by outputting a power application signal or a power cutoff signal to the power unit 130.

According to an embodiment of the present disclosure, the power control unit 174 may output the power cutoff signal to the power unit 130 so as to cut off the power of the locking operation unit 140 when the unlock signal is output by the locking control unit 172. According to this embodiment, it is possible to prevent the locking operation unit 140 from operating abnormally during driving due to a wrong control signal, circuit noise, or the like.

The driving state determination unit 176 determines whether the bicycle to be locked is in the driving state, the stop state, or the temporary stop state while driving by using sensing data about the driving condition measured by the sensor unit 120.

According to an embodiment of the present disclosure, in order to improve the accuracy of the driving state determination, the driving state determination unit 176 may be configured to include a plurality of driving state determination units 176a through 176n as illustrated in FIG. 5. In addition, each of the driving state determination units 176a through 176n may determine the driving state of the bicycle to be locked based on sensing data measured by each sensor group. This embodiment will be described in more detail with reference to FIG. 6.

In FIG. 6, it is assumed that the driving state determination unit 176 includes only a first driving state determination unit 176a, a second driving state determination unit 176b, and a third driving state determination unit 176c.

Referring to FIG. 6, the first driving state determination unit 176a may determine a first state of the bicycle to be locked based on sensing data measured by a first sensor group 121 and determine a second state of the bicycle to be locked based on sensing data measured by a second sensor group 122. Likewise, the third driving state determination unit 176c may determine a third state of the bicycle to be locked based on sensing data measured by a third sensor group 123.

As illustrated in FIG. 6, each of the sensor groups 121 through 123 may include only one sensor or include a plurality of sensors. In addition, although one sensor belongs to one sensor group in FIG. 6, the one sensor may also belong to a plurality of sensor groups depending on embodiments.

In the current embodiment, the driving state determination units 176a through 176c provide a plurality of pieces of state information determined based on sensing data measured by different sensor groups. In addition, as described above, the locking control unit 172 may strictly control the locking operation by considering all of the pieces of state information. For example, the locking control unit 172 may operate to output the lock signal only when all of the pieces of state information indicate the stop state.

In the above embodiment, it is described that the locking control unit 172 controls the locking operation by considering all of the pieces of state information determined by the first through third driving state determination units 176a through 176c. However, according to another embodiment of the present disclosure, the locking control unit 172 may control the locking operation by considering only some of the pieces of state information.

For example, when an abnormality is detected in a sensor included in the first sensor group 121 through a periodic built-in test, the locking control unit 172 may control the locking operation based only on determination results of the second and third driving state determination units 176b and 176c.

For another example, an accuracy score of each of the first through third driving state determination units 176a through 176c may be calculated, and the locking control unit 172 may control the locking operation based only on determination results of two driving state determination units having relatively high accuracy scores. Likewise, if there are n driving state determination units, the locking control unit 172 may use only determination results of top k (where k is a natural number of 1 to n) driving state determination units based on the accuracy scores. Here, the accuracy scores may be given in various ways. For example, the accuracy scores may be calculated by giving the same initial point to each driving state determination unit and then giving more accuracy points to a driving state determination unit which has produced a relatively accurate driving state determination result and deducting accuracy points from a driving state determination unit which has produced a relatively inaccurate determination result. Here, whether a determination result is accurate or inaccurate may be determined based on determination results of a majority of the driving state determination units. For example, when the majority of the driving state determination units determine that the bicycle to be locked is in the stop state, the driving state and the temporary stop state while driving may be determined as relatively inaccurate determination results.

A driving state determination method of each driving state determination unit may also vary according to types of sensors included in each sensor group. This will be briefly described using examples.

For example, when a first sensor group includes at least one of an acceleration sensor, a gyro sensor, and a geomagnetic sensor, a first driving state determination unit may determine that the bicycle to be locked is in the driving state if a change in sensing data measured by the first sensor group for a preset period of time is equal to or greater than a threshold value. Here, the threshold value may be a preset, fixed value or a variable value that is adjusted according to a driving pattern of the rider. Alternatively, the threshold value may be set by the rider through the rider terminal 200.

For another example, when a second sensor group includes a magnetic sensor installed on a wheel of the bicycle to be locked to detect rotation of the wheel, a second driving state determination unit may determine that the bicycle to be locked is in the driving state if the rotation of the wheel is detected by the second sensor group.

For another example, when a third sensor group includes a position measuring sensor for measuring the position of the bicycle to be locked, a third driving state determination unit may determine that the bicycle to be locked is in the driving state if a change in the position of the bicycle to be locked is detected by the third sensor group.

For another example, when a fourth sensor group includes an image sensor for capturing an image of an area around the bicycle to be locked, a fourth driving state determination unit may determine that the bicycle to be locked is in the driving state if a change in the image of the area around the bicycle to be locked is detected by the fourth sensor group.

Since the rider may temporarily stop the bicycle for various reasons while riding the bicycle, the driving state determination unit 176 needs to distinguish between the stop state and the temporary stop state while driving.

In an embodiment, the driving state determination unit 176 may detect whether the rider is riding on the bicycle to be locked by using a pressure sensor attached to a saddle of the bicycle to be locked and determine whether the bicycle to be locked is in the temporary stop state while driving based on the detection result. For example, even when a change in sensing value is not observed in an acceleration sensor, a gyro sensor, etc., if a pressure value measured by the pressure sensor is equal to or greater than a threshold value, the driving state determination unit 176 may determine that the bicycle to be locked is in the temporary stop state while driving.

In an embodiment, the driving state determination unit 176 may detect left and right tilts of the bicycle to be locked using a tilt sensor and determine whether the bicycle to be locked is in the temporary stop state while driving based on the detected left and right tilts. Here, the tilt sensor may be configured as any sensor as long as it can measure the left and right tilts of the bicycle to be locked. For example, the tilt sensor may include a gyro sensor, an acceleration sensor, or the like, and a tilt calculation algorithm widely known in the art may be incorporated herein by reference.

In the current embodiment, the driving state determination unit 176 may determine that the bicycle to be locked is in the temporary stop state while driving if the left and right tilts of the bicycle to be locked which are measured by the tilt sensor are less than a preset threshold value. This is because a bicycle in the driving state or the temporary stop state while driving is very unlikely to lie at more than a certain angle. Here, the threshold value may be a preset, fixed value or a variable value that is adjusted according to the driving pattern of the rider. Alternatively, the threshold value may be set by the rider through the rider terminal 200.

In an embodiment, the driving state determination unit 176 may determine whether the bicycle to be locked is in the temporary stop state while driving based on the locking pattern of the locking apparatus 100. That is, when the locking pattern of the locking apparatus 100 analyzed by the locking pattern analysis unit 178 may be utilized to determine the temporary stop state while driving. An embodiment of the present disclosure will now be described with reference to FIG. 6.

The locking pattern analysis unit 178 may analyze the locking pattern of the rider based on the sensing data measured by the sensor unit 120 and a locking history stored in the storage unit 110. Here, the locking pattern may include, for example, a locking position where a locking operation was performed, a time when the locking operation was performed, a distance between a position where an unlocking operation was performed and the position where the locking operation was performed or a difference between a time when the unlocking operation was performed and a time when the locking operation was performed, a speed pattern, and the like.

More specifically, the locking pattern analysis unit 178 may analyze the locking history and produce the position and time, at which the locking operation was performed a predetermined number of times or more, as locking pattern information. In addition, as illustrated in FIG. 6, a distance or time between a time when an unlocking operation 181 was performed and a time when a locking operation 182 was performed may be analyzed to produce the locking pattern information. In addition, a speed pattern in a section between the time when the unlocking operation 181 was performed and the time when the locking operation 182 was performed may be produced as the locking pattern information.

Using the locking pattern information described above, the driving state determination unit 176 may accurately determine the temporary stop state while driving.

In an embodiment, even if the driving of the bicycle to be locked is not detected in the sensing data, the driving state determination unit 176 may determine that the bicycle to be locked is in the temporary stop state while driving when a distance between the locking position included in the locking pattern and the current position of the bicycle to be locked is equal to or greater than a preset distance. This can be understood as using the fact that the bicycle to be locked is highly likely to be parked again around a parking place frequently used by the bicycle rider or a place frequently visited by the bicycle rider.

In an embodiment, even if the driving of the bicycle to be locked is not detected in the sensing data, the driving state determination unit 176 may determine that the bicycle to be locked is in the temporary stop state while driving when a difference between the locking time included in the locking pattern and a current time is equal to or greater than a preset difference. This can be understood as using the fact that if there is a time during which the bicycle is mainly driven, the driving of the bicycle is highly likely to be stopped after the time.

In an embodiment, even if the driving of the bicycle to be locked is not detected in the sensing data, the driving state determination unit 176 may determine that the bicycle to be locked is in the temporary stop state while driving when the similarity between at least one of a distance between a position where the unlocking operation was performed immediately before and a current position and a difference between a time when the unlocking operation was performed and a current time and a previously analyzed locking pattern is less than a preset threshold value.

According to an embodiment of the present disclosure, if the occurrence of the locking event is detected when the driving state determination unit 176 determines that the bicycle to be locked is in the temporary stop state while driving, a notification may be provided to the rider terminal 200. In this case, whether to perform the locking operation may be determined according to the rider's selection.

Until now, some embodiments in which the driving state determination unit 176 determines whether the bicycle to be locked is in the temporary stop state while driving by using the locking pattern information have been described. The driving state determination unit 176 may determine the state of the bicycle to be locked according to any one of the above-described embodiments and determine whether the bicycle to be locked is in the temporary stop state while driving according to a combination of the embodiments. Although not illustrated in FIG. 2, the locking apparatus 100 may be configured to further include an input unit (not illustrated) and a display unit (not illustrated).

The input unit (not illustrated) receives various data, commands and/or information from the rider. In particular, the input unit (not illustrated) may receive information about a command indicating the locking or unlocking operation of the locking apparatus 100 from the rider. The input unit (not illustrated) may include any form of input media well known in the art to which the present disclosure pertains.

The display unit (not illustrated) displays various data, commands, information and/or graphical user interfaces (GUIs) to a user. Specifically, the display unit (not illustrated) may display locking state information of the locking apparatus 100, driving information calculated based on sensing data, and the like. The display unit (not illustrate) may include any form of display medium well known in the art to which the present disclosure pertains.

The locking apparatus 100 may include at least some of the components described above. That is, not all of the components described above are essential components of the locking apparatus 100, and the locking apparatus 100 may also be configured using only some of the components.

Each component illustrated in FIG. 2 through 6 may mean, but is not limited to, a software or hardware component such as a Field Programmable Gate Array (FPGA) or Application Specific Integrated Circuit (ASIC). A component may advantageously be configured to reside on the addressable storage medium and configured to execute on one or more processors. The functionality provided for in the components may be further separated into additional components or combined into fewer components.

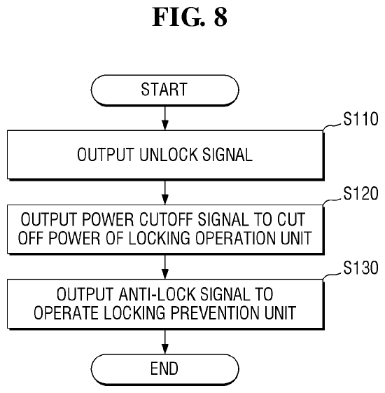

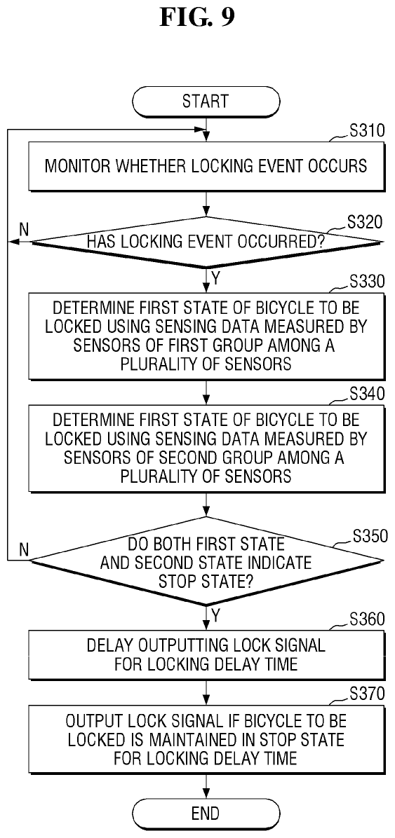

Until now, the configuration and operation of the locking apparatus 100 according to the embodiment of the present disclosure have been described with reference to FIGS. 2 through 7. It will be clearly understood by those of ordinary skill in the art that the embodiments of the present disclosure described above with reference to FIGS. 2 through 7 can be referred to in an abnormal locking prevention method which will be described later. Next, an abnormal locking prevention method according to another embodiment of the present disclosure will be described in detail with reference to FIGS. 8 through 11.

Hereinafter, each operation of the abnormal locking prevention method according to the embodiment of the present disclosure may be performed by the control unit 170 of the locking apparatus 100 unless otherwise stated. However, the subject of each operation may be omitted for ease of description. In addition, each operation of the abnormal locking prevention method may be an operation performed by the locking apparatus 100 as an abnormal locking prevention program is executed by the control unit 170.

FIG. 8 is a flowchart illustrating an abnormal locking prevention method that may be performed in response to an unlocking event. However, this is merely an embodiment for achieving the objectives of the present disclosure, and some operations can be added or removed as needed.

If a predetermined unlocking condition is satisfied, an unlocking event may occur. Since the unlocking condition has been described above, a description thereof is omitted.

In response to the unlocking event, the control unit 170 outputs an unlock signal to trigger an unlocking operation of the locking apparatus 100 (operation S110). When the unlocking operation is performed, the control unit 170 outputs a power cutoff signal to the power unit 130 to block a locking operation of the locking apparatus 100 (operation S120). Accordingly, an abnormal locking operation that may be caused by a wrong control signal can be prevented.

In addition, the control unit 170 outputs an anti-lock signal to the locking prevention unit 150 (operation S130). Accordingly, since the locking operation of the locking operation unit 140 during driving is physically blocked, the abnormal locking operation can be prevented even if power is applied to the locking operation unit 140.

Next, an abnormal locking prevention method that may be performed in response to a locking event will be described with reference to FIG. 9. In the flowchart of FIG. 9, a case where two sensor groups are formed is used as an example for ease of understanding, but the number of sensor groups can vary as described above.

If a predetermined locking condition is satisfied, a locking event may occur. Since the locking condition has been described above, a description thereof is omitted.

The control unit 170 monitors whether the locking event occurs and determines a current state of a bicycle to be locked when the locking event occurs (operations S310 and S320). Specifically, the control unit 170 determines a first state of the bicycle to be locked using sensor data measured by a first sensor group and determines a second state of the bicycle to be locked using sensor data measured by a second sensor group (operations S330 and S340). Since the sensor groups have been described above, a description thereof is omitted to avoid redundancy.

The control unit 170 does not output a lock signal when any one of the first state and the second state indicates a driving state or a temporary stop state while driving (operation S350). On the contrary, when both the first state and the second state indicate a stop state, the control unit 170 may output the lock signal (operations S350 through 370).

However, in order to perform a locking operation more strictly, the control unit 170 may delay outputting the lock signal for a locking delay time (operation S360). Here, the locking delay time may be a preset, fixed value or a variable value that varies according to a situation. Since an embodiment in which the locking delay time varies according to a situation has been described above, a description thereof is omitted.

The control unit 170 outputs the delayed lock signal if the bicycle to be locked is maintained in the stop state for the locking delay time (operation S370).

Until now, the abnormal locking method that may be performed in response to the locking event has been described with reference to FIG. 9. According to the above description, when it is determined that a bicycle to be locked is in the driving state by using a sensor provided in a locking apparatus, a locking operation is prevented. In addition, the driving state of the bicycle is determined based on sensing data of each of a plurality of sensor groups. Accordingly, the accuracy of the driving state determination can be improved, and the problem of the reliability of the locking operation being reduced by misjudgment of the driving state can be solved.

Next, an embodiment of utilizing locking prevention information received from the rider terminal 200 will be described with reference to FIGS. 10 and 11.

Referring to FIGS. 10 and 11, information about a locking prevention time and/or a locking prevention place may be set through user interfaces 210 and 220 provided by the rider terminal 200. The user interfaces may be, for example, user interfaces provided by an application installed in the rider terminal 200.

More specifically, the locking apparatus 100 may receive a locking prevention time 211 set through the user interface 210 and may not perform a locking operation during the locking prevention time 211. For example, during the locking prevention time 211, power supplied to the locking operation unit 140 may be cut off, and the locking prevention unit 150 may be operated. In addition, even if a locking event occurs, the control unit 170 may not output a lock signal.

According to an embodiment, when the locking event occurs, a push notification may be provided to the rider terminal 200. In this case, whether to perform the locking operation may be determined according to a rider's selection.

As illustrated in FIG. 11, a theft safe area may be set as a locking prevention place 221 through the user interface 220. When receiving the locking prevention place 221, the locking apparatus 100 may not perform the locking operation around the place. For example, when the locking apparatus 100 enters the place, power supplied to the locking operation unit 140 may be cut off, and the locking prevention unit 150 may be operated. In addition, even if the locking event occurs, the control unit 170 may not output the lock signal.

However, according to an embodiment, a push notification may be provided to the rider terminal 200 as described above. In this case, whether to perform the locking operation may be determined according to the rider's selection.

According to an embodiment of the present disclosure, the locking delay time described above may be adjusted based on the information about the locking prevention time and/or the locking prevention place. For example, the locking delay time may be adjusted to a larger value around the locking prevention place or during the locking prevention time. More specifically, the locking delay time may be adjusted based on at least one of a distance between a current position of a bicycle to be locked and the locking prevention place and/or a difference between a current driving time and the locking prevention time.

In addition, when a condition for the occurrence of the locking event is based on a separation distance between the rider terminal 200 and the locking apparatus 100, the separation distance may also be adjusted based on the locking prevention time and/or the locking prevention place. For example, the separation distance may be adjusted to a larger value around the locking prevention place or during the locking prevention time.

According to an embodiment of the present disclosure, the locking prevention time and/or the locking prevention place may not be information input by the rider but may be information automatically set based on driving information of the bicycle to be locked which is recorded in the rider terminal 200. For example, based on sensing data about a driving condition measured by a sensor of the rider terminal 200 or the sensor unit 120 of the locking apparatus 100, the rider terminal 200 may record driving information of the bicycle to be locked and analyze a driving pattern. Here, the driving information may include at least one of a driving route and a driving time, and the driving pattern may denote, for example, at least one of a driving route and a driving time that are repeatedly used. The rider terminal 200 may automatically set the locking prevention time and/or the locking prevention place based on the driving pattern. For example, if the rider commutes using the bicycle to be locked, information such as a commute time, a place of residence (e.g., home), a place of work (e.g., company), and a commute route may be automatically set as the locking prevention time and/or the locking prevention place. In addition, according to an embodiment, if the rider terminal 200 recommends the above information to the rider, the locking prevention time and/or the locking prevention place may be set according to the rider's selection.

In addition, according to an embodiment of the present disclosure, the locking prevention time and/or the locking prevention place may be information set in the rider terminal based on statistical information about locking prevention information set in terminals of a plurality of riders. For example, when there is a driving information management server linked to each rider terminal, the driving information management server may collect information about locking prevention times and/or locking prevention places that are input to the rider terminals or automatically set, determine information about a place and/or time, which is set as a locking prevention place and/or time by many riders, through statistical processing, and provide the determined information to each rider terminal. In addition, the rider terminal 200 may automatically set a locking prevention time and/or a locking prevention place based on the information received from the driving information management server or may recommend the locking prevention time and/or the locking prevention place to the rider. According to this embodiment, it is possible to provide more accurate information about a place (e.g., a crosswalk, a crossing) and/or time, at which the locking operation must not be performed, based on statistically processed information.

Until now, the embodiment of preventing a locking operation based on locking prevention information received from the rider terminal 200 has been described with reference to FIGS. 10 and 11. In the above embodiment, only an example of using the locking prevention information such as a locking prevention time and/or a locking prevention place has been described.

However, on the contrary, the locking apparatus 100 may also perform a locking function based on a locking time and/or a locking place (e.g., a theft risk place). For example, locking time and/or locking place information may be utilized to change the locking delay time to a very small value or to change a separation distance, which is a condition for the occurrence of the locking event, to a small value in a set locking time and/or locking place.

The embodiments of the present disclosure described above may be conducted by executing a computer program which is implemented as a computer-readable code. The computer program may be transmitted from a first computing device to a second computing device via a network such as Internet and may be installed on the second computing device, and thus, the computer program may be used in the second computing device. The second computing device may comprise all of available computing devices, such as a server device, a physical server included in server pool for cloud service, and a desktop PC.

The computer program may be stored in a computer-readable medium including DVD-ROM, flash memory, or etc.

While the present disclosure has been particularly illustrated and described with reference to exemplary embodiments thereof, it will be understood by those of ordinary skill in the art that various changes in form and detail may be made therein without departing from the spirit and scope of the present disclosure as defined by the following claims. The exemplary embodiments should be considered in a descriptive sense only and not for purposes of limitation.

1. A bicycle locking apparatus having an abnormal locking prevention function, the apparatus comprising:
a sensor unit which measures a driving condition of a bicycle to be locked by using a plurality of sensors and outputs sensing data about the driving condition;
a locking operation unit which performs a locking operation or an unlocking operation on the bicycle to be locked in response to input of a lock signal or an unlock signal; and
a control unit which controls the overall operation of the bicycle locking apparatus,
wherein the control unit comprises:
a first driving state determination unit which determines a first state of the bicycle to be locked by using sensing data of a first sensor group comprising one or more of the sensors;
a second driving state determination unit which determines a second state of the bicycle to be locked by using sensing data of a second sensor group comprising one or more of the sensors, wherein the sensors included in the second sensor group are different from the sensors included in the first sensor group; and
a locking control unit which outputs the lock signal to the locking operation unit in response to a locking event that occurs when a predetermined locking condition is satisfied,
wherein the locking control unit determines that the locking event is an abnormal locking event when none of the first state and the second state indicates a stop state, controls the lock signal not to be output to the locking operation unit in response to the determination that the locking event is the abnormal locking event, and outputs the lock signal to the locking operation unit in response to the determination that the locking event is not the abnormal locking event.

2. The apparatus of claim 1, wherein the locking control unit delays outputting the lock signal for a locking delay time when both the first state and the second state indicate the stop state and outputs the delayed lock signal only when both the first state and the second state are maintained as the stop state for the locking delay time.

3. The apparatus of claim 2, wherein the control unit calculates a driving speed of the bicycle to be locked by using the sensing data about the driving condition and updates the locking delay time to a larger value as the calculated driving speed increases.

4. The apparatus of claim 2, further comprising a communication unit which receives a driving destination of the bicycle to be locked from a rider terminal, wherein the control unit updates the locking delay time to a smaller value when a distance between the driving destination and a current position of the bicycle to be locked is less than a preset distance.

5. The apparatus of claim 2, further comprising a communication unit which receives a locking prevention place or a locking prevention time of the bicycle to be locked from a rider terminal, wherein the control unit adjusts the locking delay time based on at least one of the locking prevention place and the locking prevention time.

6. The apparatus of claim 1, wherein the locking event according to the predetermined condition comprises a locking event that occurs based on a separation distance between the bicycle to be locked and a rider terminal, and further comprising a communication unit which receives a locking prevention place or a locking prevention time of the bicycle to be locked from the rider terminal, wherein the control unit adjusts the separation distance based on at least one of the locking prevention place and the locking prevention time.

7. The apparatus of claim 1, further comprising a power unit which applies or cuts off power to the locking operation unit in response to input of a power application signal or a power cutoff signal, wherein the control unit further comprises a power control unit which outputs the power application signal or the power cutoff signal to the power unit, wherein the power control unit outputs the power cutoff signal to the power unit as the unlock signal is output by the locking control unit.

8. The apparatus of claim 1, further comprising a locking prevention unit which physically blocks the locking operation of the locking operation unit in response to input of an anti-lock signal, wherein the locking control unit outputs the anti-lock signal to the locking prevention unit when the unlock signal is output according to an unlocking event.

9. The apparatus of claim 8, wherein the locking prevention unit is separated from the locking operation unit in a circuit.

10. The apparatus of claim 8, wherein when the locking operation performs the locking operation while at least one of the first state and the second state indicates a driving state, the locking prevention unit blocks the locking operation of the locking operation unit even if the anti-lock signal is not received.

11. The apparatus of claim 1, wherein the first sensor group comprises at least one of an acceleration sensor, a gyro sensor and a geomagnetic sensor, the second sensor group comprises a magnetic sensor which is installed on a wheel of the bicycle to be locked and detects rotation of the wheel, the first driving state determination unit determines the first state as the driving state when a change in the sensing data measured by the first sensor group for a preset period of time is equal to or greater than a threshold value, and the second driving state determination unit determines the second state as the driving state when the rotation of the wheel is detected by the second sensor group.

12. The apparatus of claim 1, wherein the first sensor group comprises a position measuring sensor for measuring the position of the bicycle to be locked, and the first driving state determination unit determines the first state as the driving state when a change in the position of the bicycle to be locked is detected by the first sensor group.

13. The apparatus of claim 1, wherein the first sensor group is any one of a (1-1)-th sensor group which comprises at least one of an acceleration sensor, a gyro sensor and a geomagnetic sensor, a (1-2)-th sensor group which comprises a magnetic sensor installed on a wheel of the bicycle to be locked and detecting rotation of the wheel, a (1-3)-th sensor group which comprises a position measuring sensor for measuring the position of the bicycle to be locked, and a (1-4)-th sensor group which comprises an image sensor for capturing an image of an area around the bicycle to be locked.

14. The apparatus of claim 13, wherein the first sensor group further comprises a pressure sensor which is attached to a saddle of the bicycle to be locked and detects whether a rider of the bicycle to be locked is riding on the bicycle to be locked, and the first driving state determination unit determines the first state as a temporary stop state while driving when the driving of the bicycle to be locked is not detected by the first sensor group except the pressure sensor and the riding of the rider on the bicycle to be locked is detected by the pressure sensor.

15. The apparatus of claim 13, wherein the first sensor group further comprises a tilt sensor which detects left and right tiles of the bicycle to be locked, and the first driving state determination unit determines the first state as a temporary stop state while driving when the driving of the bicycle to be locked is not detected by the first sensor group except the tilt sensor and the left and right tilts measured by the tilt sensor are less than a preset threshold value.

16. The apparatus of claim 1, further comprising a locking pattern analysis unit which analyzes a locking pattern of the rider of the bicycle to be locked by using the sensing data about the driving condition and a locking history, wherein the locking pattern comprises at least one of a distance between a position where a first unlocking operation was performed and a position where a first locking operation was performed and a difference between a time when the first unlocking operation was performed and a time when the first locking operation was performed, and the first driving state determination unit determines the first state as the temporary stop state while driving when the driving of the bicycle to be locked is not detected in the sensing data measured by the first sensor group and when the similarity between at least one of a distance between a position where a second unlocking operation was performed immediately before and a current position and a difference between a time when the second unlocking operation was performed and a current time and a previously analyzed locking pattern is less than a preset threshold value.

17. The apparatus of claim 1, further comprising a communication unit which receives locking prevention information of the bicycle to be locked from a rider terminal, wherein the locking prevention information comprises at least one of a locking prevention time and a locking prevention place, and the control unit controls a notification informing the occurrence of the locking event to be provided to the rider terminal when the occurrence of the locking event is detected while at least one of a first condition about whether a distance between a current position of the bicycle to be locked and the locking prevention place is less than a preset distance and a second condition about whether a current driving time of the bicycle to be locked corresponds to the locking prevention time is satisfied.

18. The apparatus of claim 17, wherein the locking prevention information is information automatically set in the rider terminal based on driving information of the bicycle to be locked, which is recorded in the rider terminal, without input from the rider, and the driving information comprises at least one of a driving route and a driving time.

19. The apparatus of claim 17, wherein the locking prevention information is information set in the rider terminal based on statistical information about locking prevention information set in terminals of a plurality of riders.

20. An abnormal locking prevention method performed by a locking apparatus having a plurality of sensors, the method comprising:
detecting occurrence of a locking event according to a predetermined condition;
determining a first state of a bicycle to be locked, to which the locking apparatus is attached, in response to the locking event by using sensing data of a first sensor group comprising one or more of the sensors;
determining a second state of the bicycle to be locked by using sensing data of a second sensor group comprising one or more of the sensors, wherein the sensors included in the second sensor group are different from the sensors included in the first sensor group; and
determining the locking event as an abnormal locking event when none of the first state and the second state indicates a stop state, controlling a lock signal not to be output to a locking operation unit in response to the determination that the locking event is the abnormal locking event, and outputting the lock signal for triggering a locking operation of the locking apparatus in response to the determination that the locking event is not the abnormal locking event.
